(19) United States
(12) Patent Application Publication
(10) Pub. No.: US 2018/0092361 A1
(43) Pub. Date: Apr. 5, 2018

(54) INSECTICIDAL COMPOSITION AND METHOD OF USE

(71) Applicant: HighQ Services, LLC, Cedar Park, TX (US)

(72) Inventors: Fermin Navar, Austin, TX (US); Babak Samani, Cedar Park, TX (US)

(21) Appl. No.: 15/725,068

(22) Filed: Oct. 4, 2017

Related U.S. Application Data
(60) Provisional application No. 62/403,792, filed on Oct. 4, 2016.

(51) Int. Cl. A01N 59/14; A01N 33/12; A01N 53/00; A01N 43/38; A01N 43/30; A01N 43/40

(52) U.S. Cl. CPC A01N 59/14; A01N 33/12; A01N 53/00; A01N 2300/00; A01N 43/30; A01N 43/40; A01N 43/38

(57) ABSTRACT

An aqueous composition includes boric acid in an amount of 0.01 wt % to 5 wt %; benzalkonium salt in an amount of 0.001 wt % to 3 wt %; pyrethrin in an amount of 0.001 wt % to 0.1 wt %; solubilizing agent in an amount of 0.1 wt % to 5 wt %; a bug repellent essential oil blend in an amount of 0.05 wt % to 1.5 wt %; and synergistic agent in an amount of 0.001 wt % to 1.0 wt %.

### CROSS-REFERENCE TO RELATED APPLICATION(S)

This application claims benefit of U.S. Provisional Application No. 62/403,792, filed Oct. 4, 2016, which is incorporated herein by reference in its entirety.

### FIELD OF THE DISCLOSURE

This disclosure, in general, relates to insecticidal compositions and methods of using same, particularly for treatment of bed bug infestations.

### BACKGROUND

With high mobility among the workforce and increasing affluence among would-be travelers, hotel rooms are seeing an increased usage, particularly in large metropolitan areas or resort vacation spots. Such increased usage can lead to cross-contamination of hotel sites with bedbugs and other insect infestations. Moreover, there is a risk of transferring such infestations from hotels to residences. In particular, several large metropolitan areas have experienced an epidemic of bedbugs.

As such, an improved composition and method for treating bedbugs and other infestations would be desirable.

### DETAILED DESCRIPTION

In an exemplary embodiment, the composition can be an aqueous composition incorporating boric acid, benzalkonium salt, pyrethrin, solubilizing agent, a bug repellent essential oil blend, and synergistic agent. The composition can also include a methyl phenoxy phenoxy ethoxy pyridine. In a particular example, the composition can consist essentially of water and the above components. In an exemplary method, the composition can be applied to bedding or furniture.

In an example, the aqueous composition can include boric acid in an amount of 0.01 wt % to 5 wt %. For example, the boric acid can be included in an amount of 0.1 wt % to 2.0 wt %, such as an amount of 0.5 wt % to 1.5 wt %.

In a further example, the composition includes benzalkonium salt. For example, the composition can include one or more alkyl dimethyl benzyl ammonium salts, such as alkyl dimethyl benzyl ammonium chloride. In an example, the composition includes the benzalkonium salt in an amount of 0.001 wt % to 5 wt %, such as an amount of 0.1 wt % to 3 wt %, or an amount of 0.5 wt % to 2 wt %.

In another example, the composition includes pyrethrin. The pyrethrin can be a botanical derived pyrethrin. In particular, a source including pyrethrin can include pyrethrin I, pyrethrin II, cinerin I, cinerin II, jasmolin I, jasmolin II, or combinations thereof. In an example, the composition includes pyrethrin in an amount of 0.001 wt % to 0.1 wt %. For example, the composition can include pyrethrin in an amount of 0.01 wt % to 0.08 wt %, such as approximately 0.05 wt %.

The composition can further include solubilizing agent. For example, the solubilizing agent can include anionic solubilizing agent. In an example, the anionic solubilizing agent can include a polyethylene glycol (PEG)-based agent. For example, polyethylene glycol (PEG)-based agent can include a poly ethylene glycol (PEG) modified oil, such as a PEG-modified castor oil. The PEG-based agent can include a PEG chain of 15 to 50 mers, such as 20 to 40 mers. In a particular example, the solubilizing agent can be included in an amount in a range of 0.1 wt % to 5 wt %, such as an amount in a range of 0.5 wt % to 3 wt %, or an amount of 1.5 wt % to 3 wt %.

In a further example, the composition includes a bug repellent essential oil blend. In an example, the bug repellent essential oil blend can include essential oils selected from citronella, lemongrass, thyme, neem, cedar wood, tea tree, peppermint, or combinations thereof. In particular, the bug repellent essential oil blend can include citronella in an amount of 5 wt % to 35 wt %, lemongrass in an amount of 5 wt % to 35 wt %, thyme in an amount of 5 wt % to 35 wt %, neem in an amount of 5 wt % to 35 wt %, cedar wood in an amount of 5 wt % to 35 wt %, tea tree in an amount of 5 wt % to 35 wt %, or peppermint in an amount of 5 wt % to 35 wt %. The bug repellent essential oil blend can be incorporated into the composition in an amount of 0.5 wt % to 1.5 wt %, such as an amount of 0.1 wt % to 1.0 wt % or an amount of 0.2 wt % to 0.8 wt %.

The composition can also include a synergistic agent that enhances the activity of pyrethrins or pyrethroids. In an example, the synergistic agent can include dicarboximide, piperonyl butoxide, or a combination thereof. In particular, the synergistic agents can be incorporated in amount of 0.001 wt % to 1 wt %, such as an amount of 0.05 wt % to 0.5 wt %, or an amount of 0.1 wt % to 0.3 wt %. In a particular example, the synergistic agent can include N-octyl bicycloheptene dicarboximide, for example, in an amount in the composition in a range of 0.05 wt % to 0.5 wt %, such as an amount in a range of 0.1 wt % to 0.3 wt %. In a further example, the synergistic agent can include a piperonyl butoxide, for example, in an amount in the composition of 0.05 wt % to 0.5 wt %, such as an amount of 0.05 wt % to 0.3 wt %.

In a further example, the aqueous composition can include a methyl phenoxy phenoxy ethoxy pyridine, such as 2-[1-methyl-2-(4-phenoxyphenoxy)ethoxy]pyridine or 2-((1-(4-phenoxyphenoxy)propan-2-yl)oxy)pyridine. For example, the ethyl phenoxy phenoxy ethoxy pyridine can be included in the amount of 0.01 wt % to 1.0 wt %, such as an amount of 0.1 wt % to 0.3 wt %.

To form the insecticidal composition, the amount of water and boric acid can be blended. For example, the boric acid and water can be heated to a temperature in a range of 100° F. to 150° F. to dissolve the boric acid in the water to form solution A. Another solution (solution B) including water, benzalkonium compositions, and pyrethrin can be blended. The boric acid solution A and the second aqueous solution B can be blended together to form an AB solution. Other elements can be blended with the AB solution, for example, incorporating the solubilizing agent, bug repellent essential oils, methyl phenoxy phenoxy ethoxy pyridine, and synergistic agent, such as N-octyl bicycloheptene dicarboximide, piperonyl butoxide, or a combination thereof. Such blending can be carried out at lower temperatures, such as temperatures below 100° F., such as room temperature (approximately 75° F.).

In use, the aqueous compositions can be applied to bedding or furniture to kill an existing infestation or repel future infestations. In particular, the composition can be sprayed over existing bedding or furniture. In a further example, the composition can be sprayed on draperies, carpets, seating, or other porous materials. In particular, many of the active components of the above composition are naturally sourced, yet provide desired effectiveness when treating bedbug infestations.

### Example

The composition of Table 1 is tested for efficacy against bedbugs.

Bedbugs (Cimex lectularius) are exposed to the composition of Table 1. The bug repellent essential oil blend includes citronella, lemongrass, thyme, neem, cedar wood, tea tree, and peppermint. Untreated bed bugs are used as a control. After treatment, specimens are sorted into 35 mm petri dishes with cardboard harborage and observed for 6 days.

TABLE 1
Composition for Treating Bed Bugs

| Ingredients | % |
|---|---|
| Water | 6.50000% |
| Boric Acid | 1.00000% |
| Water | 85.98300% |
| MASON ® CS-428 (mfg suggest .6%) | 2.00000% |
| Pilot Maquat LC125-50% (EPA approved) (Benzalkonium | 1.00000% |
| Chloride) | |
| Premium Pyrocide #175 (Pyrethrins) | 0.05000% |
| Jeechem FS-102 (Hexylene Glycol, PEG-25 | 2.50000% |
| HydrogenateCastor | |
| Oil, PEG-40 Hydrogenated Castor Oil) | |
| Bug Repellent EO #2 | 0.5000% |
| Nylar @ 50% Concentration (2-[1-Methyl-2-(4- | 0.20000% |
| Phenoxyphenoxy) Ethoxy] Pyridine) | |
| MGK 264 Insecticide Synergist (N-Octyl Bicycloheptene | 0.16700% |
| Dicarboximide) | |
| Technical Piperonyl Butoxide (Piperonyl Butoxide, | 0.10000% |
| Technical) | |
| pH 3.7 | 100.0000% |

The insecticide formulation records 43% bed bug mortality within 24 hours after the applications and reaches 100% mortality by completion of the 6-day study. The mortality rates of the specimens that were treated with the insecticide formulation are significantly higher than the mortality rates (near 0%) of the untreated control population.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. An aqueous composition comprising:
boric acid in an amount of 0.01 wt % to 5 wt %;
a benzalkonium salt in an amount of 0.001 wt % to 3 wt %;
pyrethrin in an amount of 0.001 wt % to 0.1 wt %;
a solubilizing agent in an amount of 0.1 wt % to 5 wt %;
a bug repellent essential oil blend in an amount of 0.05 wt % to 1.5 wt %; and
a synergistic agent in an amount of 0.001 wt % to 1.0 wt %.

2. The aqueous composition of claim 1, wherein the boric acid is included in an amount of 0.1 wt % to 2.0 wt %.

3. The aqueous composition of claim 1, wherein the benzalkonium salt includes an alkyl dimethyl benzyl ammonium salt.

4. The aqueous composition of claim 1, wherein the benzalkonium salt is included in an amount of 0.1 wt % to 2.0 wt %.

5. The aqueous composition of claim 1, wherein the pyrethrin is included in an amount of 0.01 wt % to 0.08 wt %.

6. The aqueous composition of claim 1, wherein the solubilizing agent includes an anionic solubilizing agent.

7. The aqueous composition of claim 6, wherein the anionic solubilizing agent includes poly ethylene glycol (PEG) based agent.

8. The aqueous composition of claim 7, wherein the poly ethylene glycol (PEG) based agent includes PEG-modified castor oil.

9. The aqueous composition of claim 1, wherein the solubilizing agent is included in an amount of 0.5 wt % to 3.0 wt %.

10. The aqueous composition of claim 1, wherein the bug repellent essential oil blend includes essential oils selected from citronella, lemongrass, thyme, neem, cedar wood, tea tree, peppermint, or combinations thereof.

11. The aqueous composition of claim 1, wherein the bug repellent essential oil blend includes:
citronella in an amount of 5 wt % to 35 wt %;
thyme in an amount of 5 wt % to 35 wt %;
neem in an amount of 5 wt % to 35 wt %;
cedar wood in an amount of 5 wt % to 35 wt %;
tea tree in an amount of 5 wt % to 35 wt %; and
peppermint in an amount of 5 wt % to 35 wt %.

12. The aqueous composition of claim 1, wherein the bug repellent essential oil blend is included in an amount of 0.1 wt % to 1.0 wt %.

13. The aqueous composition of claim 1, wherein the synergistic agent includes dicarboximide, piperonyl butoxide, or a combination thereof.

14. The aqueous composition of claim 1, wherein the synergistic agent is included in a range of 0.05 wt % to 0.5 wt %.

15. The aqueous composition of claim 1, further comprising ethyl phenoxy phenoxy ethoxy pyridine in an amount of 0.001 wt % to 1.0 wt %.

16. A method for treating bedding, the method comprising:
applying a composition to bedding, the composition comprising:
boric acid in an amount of 0.01 wt % to 5 wt %;
a benzalkonium salt in an amount of 0.001 wt % to 3 wt %;
pyrethrin in an amount of 0.001 wt % to 0.1 wt %;
a solubilizing agent in an amount of 0.1 wt % to 5 wt %;
a bug repellent essential oil blend in an amount of 0.05 wt % to 1.5 wt %; and
a synergistic agent in an amount of 0.001 wt % to 1.0 wt %.

17. A composition consisting essentially of:
water;
boric acid in an amount of 0.01 wt % to 5 wt %;
a benzalkonium salt in an amount of 0.001 wt % to 3 wt %;
pyrethrin in an amount of 0.001 wt % to 0.1 wt %;
a solubilizing agent in an amount of 0.1 wt % to 5 wt %;
a bug repellent essential oil blend in an amount of 0.05 wt % to 1.5 wt %;
methyl phenoxy phenoxy ethoxy pyridine in an amount of 0.001 wt % to 1.0 wt %; and
a synergistic agent in an amount of 0.001 wt % to 1.0 wt %.

18. The composition of claim 17, wherein the boric acid is included in an amount of 0.1 wt % to 2.0 wt %.

19. The composition of claim 17, wherein the benzalkonium salt includes an alkyl dimethyl benzyl ammonium salt.

20. (canceled)

21. (canceled)

22. The composition of claim 17, wherein the solubilizing agent includes an anionic solubilizing agent.

23.-30. (canceled)
